(19) United States
(12) Patent Application Publication
(10) Pub. No.: US 2018/0373772 A1
(43) Pub. Date: Dec. 27, 2018

(54) METHOD FOR MAINTAINING SYNCHRONIZATION OF RESOURCES IN WIRELESS COMMUNICATION SYSTEM, AND APPARATUS THEREFOR

(71) Applicant: LG ELECTRONICS INC., Seoul (KR)

(72) Inventors: Dongjoo KIM, Seoul (KR); Seongyun KIM, Seoul (KR); Seungmyeong JEONG, Seoul (KR)

(73) Assignee: LG ELECTRONICS INC., Seoul (KR)

(21) Appl. No.: 15/739,845

(22) PCT Filed: Jan. 15, 2016
(86) PCT No.: PCT/KR2016/000449

§ 371 Date: Dec. 26, 2017

Related U.S. Application Data
(60) Provisional application No. 62/193,601, filed on Jul. 17, 2015.
(60) Provisional application No. 62/211,869, filed on Aug. 30, 2015.

(51) Int. Cl. G06F 17/30; H04L 29/06

(52) U.S. Cl. CPC G06F 17/30575; H04L 63/101; G06F 17/30365

(57) ABSTRACT

A method for maintaining synchronization between an original resource and an announced resource in a wireless communication system, according to one embodiment of the present invention, is performed by a first apparatus, and may comprise the steps of: if the target of a request message received from a second apparatus is an announced resource, checking the operation type of the request message; if the operation type is UPDATE/DELETE, checking whether a sender of the request message is a generator of the announced resource; and if the sender of the request message is the generator of the announced resource, approving the request indicated by the request message.

### TECHNICAL FIELD

The present invention relates to a method of maintaining synchronization of resources in a wireless communication system and an apparatus therefor.

### BACKGROUND ART

In the era of ubiquitous computing, machine-to-machine (M2M) communication technology has attracted much attention. The M2M communication technology is under study in many standard development organizations (SDOs) such as TIA, ATIS, ETSI, and oneM2M.

An M2M communication system may have a resource oriented architecture (RoA) and, thus, access to multiple resources may be efficient. Such access may be performed for the same operation (e.g., creation, retrieval, deletion, and update) for multiple resources.

A oneM2M system supports resource announcement capable of informing a remote common service entity (CSE) of the presence of a specific resource to facilitate discovery of the specific resource present in an arbitrary CSE. In this case, the oneM2M system has difficulty maintaining synchronization when bidirectional synchronization is needed according to an announced resource, an access control privilege of an announced attribute included in the announced resource, and an access control privilege of an original resource. The present disclosure proposes a method of solving the above problem.

### DETAILED DESCRIPTION OF THE INVENTION

### Technical Problems

The present invention provides a method of maintaining synchronization of resources according to announcement.

The technical objects that can be achieved through the present invention are not limited to what has been particularly described hereinabove and other technical objects not described herein will be more clearly understood by persons skilled in the art from the following detailed description.

### Technical Solutions

According to an aspect of the present invention, provided herein is a resource synchronization method of maintaining synchronization between an original resource and an announced resource in a wireless communication system. The method is performed by a first device and includes, checking an operation type of a request message when a target of the request message received from a second device is the announced resource, determining whether an originator of the request message is a creator of the announced resource when the operation type is Update or Delete, and granting a request indicated by the request message when the originator of the request message is the creator of the announced resource.

Additionally or alternatively, the method may further include determining whether the target of the request message is the announced resource.

Additionally or alternatively, the method may further include checking an access rights of the second device using an access control policy of a target resource of the request message when the target of the request message is not the announced resource or when the operation type is not Update or Delete.

Additionally or alternatively, the determining whether the originator of the request message is the creator of the announced resource may include comparing a “From” parameter of the request message with a “link” attribute of the announced resource.

Additionally or alternatively, the method may further include denying the request indicated by the request message when the originator of the request message is not the creator of the announced resource.

In another aspect of the present invention, provided herein is a device for maintaining synchronization between an original resource and an announced resource in a wireless communication system, including a radio frequency (RF) unit, and a processor configured to control the RF unit, wherein the processor checks an operation type of a request message when a target of the request message received from a second device is the announced resource, determines whether an originator of the request message is a creator of the announced resource when the operation type is Update or Delete, and grants a request indicated by the request message when the originator of the request message is the creator of the announced resource.

Additionally or alternatively, the processor may determine whether the target of the request message is the announced resource.

Additionally or alternatively, the processor may check access rights of the second device using an access control policy of a target resource of the request message when the target of the request message is not the announced resource or if the operation type is not Update or Delete.

Additionally or alternatively, the processor may compare a “From” parameter of the request message with a “link” attribute of the announced resource to determine whether the originator of the request message is the creator of the announced resource.

Additionally or alternatively, when the originator of the request message is not the creator of the announced resource, the processor may deny the request indicated by the request message.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to an embodiment of the present invention, synchronization of two resources can be efficiently processed while maintaining security.

More specifically, random change and deletion of an announced resource can be prevented and synchronization between the announced resource and an original resource can be maintained.

The announced attribute can be prevented from being randomly changed and deleted and therefore synchronization between the announced attributed and the original attribute can be maintained.

Effects according to the present invention are not limited to what has been particularly described hereinabove and other advantages not described herein will be more clearly understood by persons skilled in the art from the following detailed description of the present invention.

### DESCRIPTION OF DRAWINGS

The accompanying drawings, which are included to provide a further understanding of the invention, illustrate embodiments of the invention and together with the description serve to explain the principle of the invention.

FIG. 1 illustrates a functional structure of an M2M communication system.

FIG. 2 illustrates a configuration supported by an M2M communication system based on an M2M functional structure.

FIG. 3 illustrates common service functions provided by an M2M communication system.

FIG. 4 illustrates resource structures in an M2M application service node and an M2M infrastructure node.

FIG. 5 illustrates resource structures in an M2M application service node (e.g., an M2M device) and an M2M infrastructure node.

FIG. 6 illustrates a procedure for exchanging request and response messages used in an M2M communication system.

FIG. 7 illustrates the structure of an <accessControlPolicy> resource.

FIG. 8 illustrates a registration procedure in an M2M communication system.

FIG. 9 illustrates a resource announcement procedure.

FIGS. 10 and 11 illustrate a <container> resource and a <containerAnnc> resource.

FIG. 12 illustrates a procedure according to an embodiment of the present invention.

FIG. 13 illustrates a procedure according to an embodiment of the present invention.

FIG. 14 illustrates a procedure according to an embodiment of the present invention.

FIG. 15 illustrates a procedure according to an embodiment of the present invention.

FIG. 16 illustrates a procedure according to an embodiment of the present invention.

FIG. 17 is a block diagram of devices configured to implement embodiment(s) of the present invention.

### BEST MODE FOR CARRYING OUT THE INVENTION

Reference will now be made in detail to the preferred embodiments of the present invention, examples of which are illustrated in the accompanying drawings. The following detailed description of the invention includes details to aid in full understanding of the present invention. Those skilled in the art will appreciate that the present invention can be implemented without these details.

In some cases, to prevent the concept of the present invention from being obscured, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

In the present disclosure, devices for device-to-device communication, that is, M2M devices, may be fixed or mobile and include devices which communicate with a server for device-to-device communication, that is, an M2M server to transmit/receive user data and/or various types of control information. The M2M devices may be referred to as terminal equipment, mobile stations (MSs), mobile terminals (MTs), user terminals (UTs), subscriber stations (SSs), wireless devices, personal digital assistants (PDA), wireless modems, handheld devices and the like. In the present invention, the M2M server refers to a fixed station which communicates with M2M devices and/or other M2M servers, and exchanges various types of data and control information with M2M devices and/or other M2M servers by communicating with the M2M devices and/or other M2M servers.

A description will be given of technology associated with the present invention.

M2M Applications

These are applications that execute service logic and use a common service entity (CSE) accessible through an open interface. The M2M applications can be installed in an M2M device, an M2M gateway or an M2M server.

M2M Service

This is a set of functions that can be used by the M2M CSE through standardized interfaces.

oneM2M defines a common M2M service framework (or service platform, CSE or the like) for various M2M applications (or application entities (AEs)). M2M applications can be considered as software implementing service logic such as e-Health, City Automation, Connected Consumer and Automotive. The oneM2M service framework includes functions commonly necessary to implement various M2M applications. Accordingly, it is possible to easily implement various M2M applications using the oneM2M service framework without configuring frameworks necessary for the respective M2M applications. This can integrate M2M markets currently divided into many M2M verticals, such as smart building, smart grid, e-Heath, transportation and security, and thus remarkable growth of the M2M markets is expected.

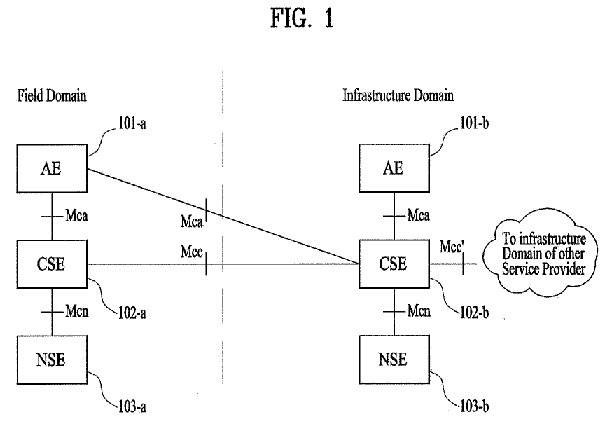

FIG. 1 illustrates the architecture of an M2M communication system. Each entity will now be described.

Application entity (AE, 101): Application entity provides application logic for end-to-end M2M solutions. Examples of the application entity include fleet tracking application, remote blood sugar monitoring application, remote power metering and controlling application.

Common service entity (CSE, 102): CSE comprises the set of “service functions” that are common to M2M environments and specified by oneM2M. Such service functions are exposed to AEs and other CSEs through reference points X and Y and used by the AEs and other CSEs. The reference point Z is used for accessing underlying network service entities.

Examples of the service functions provided by the CSE include data management, device management, M2M subscription management and location service. These functions can be logically classified into common service functions (CSFs). Some CSFs in the CSE are mandatory and some may be optional. Further, some functions in the CSFs are mandatory and some functions may be optional (e.g. some of application software installation, firmware update, logging and monitoring functions in “device management” CSF are mandatory functions and some are optional functions.)

Underlying network service entity (NSE, 103): provides services to the CSEs. Examples of such services include device management, location services and device triggering. No particular organization of the NSEs is assumed. Note: underlying networks provide data transport services between entities in the oneM2M system. Such data transport services are not included in the NSE.

The reference points shown in FIG. 1 will now be described.

Mca Reference Point

This is the reference point between an AE and a CSE. The Mca reference point allows the CSE to communicate with the AE such that the AE can use the services provided by the CSE.

The services provided through the Mca reference point are dependent on the functionality supported by the CSE. The AE and the CSE may or may not be co-located within the same physical entity.

Mcc Reference Point

This is the reference point between two CSEs. The Mcc reference point allows a CSE to use the services of another CSE in order to fulfill needed functionality. Accordingly, the Mcc reference point between two CSEs is supported over different M2M physical entities. The services offered via the Mcc reference point are dependent on the functionality supported by the CSEs.

Mcn Reference Point

This is the reference point between a CSE and an NSE. The Mcn reference point allows a CSE to use the services (other than transport and connectivity services) provided by the NSE in order to fulfill the needed functionality. It means services other than simple service such as transport and connectivity, for example, services such as device triggering, small data transmission and positioning.

Mcc′ Reference Point

This is the reference point is used for communication between CSEs respectively belongs to different M2M service providers. Mcc′ references point is similar to Mcc reference point in respect of connecting CSEs each other, but Mcc′ reference point expands Mcc reference point to different M2M service providers while Mcc reference point is limited to communication in a single M2M service provider.

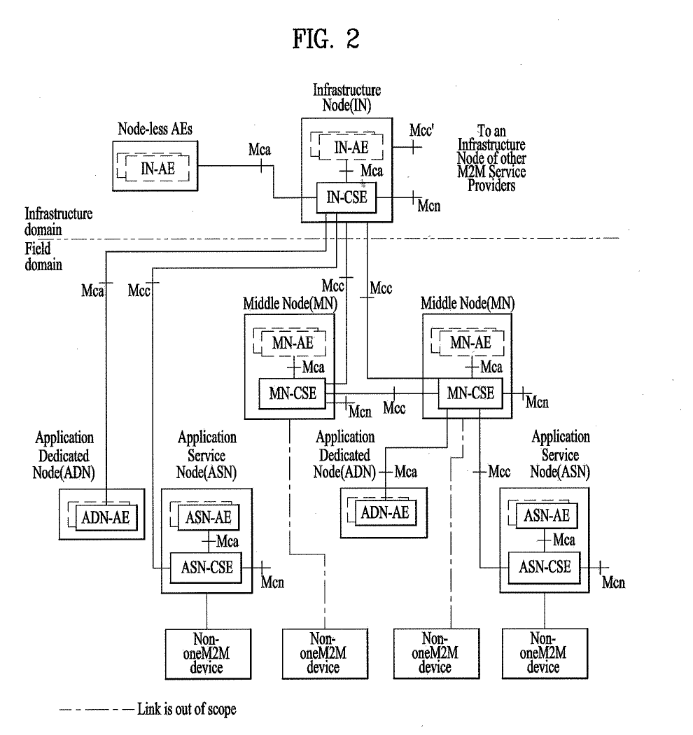

FIG. 2 illustrates compositions supported by M2M communication system based on the architecture. The M2M communication system may support more various compositions without being limited to the illustrated compositions. A concept, which is called to node, important for understand the illustrated compositions will be explained.

Application Dedicated Node (ADN): An application dedicated node is a node that contains at least one M2M application and does not contain a CSE. The ADN can communicate over an Mca reference point with one middle node or one infrastructure node. The ADN can be present in an M2M device.

Application Service Node (ASN): An application service node is a node that contains at least one CSE and has at least one M2M application. The ASN can communicate over a Mcc reference point with one middle node or one infrastructure node. The ASN can be present in an M2M device.

Middle Node (MN): A middle node is a node that contains at least one CSE and may contain M2M applications. The middle node communicates over a Mcc references point with at least two nodes belonging to the following different category:
one or more ASNs;
one or more middle nodes (MNs); and
one infrastructure structure.

The MN can be connected with the ADN through an Mca reference point. The MN can be present in an M2M gateway.

Infrastructure Node (IN): An infrastructure node is a node that contains one CSE and may contain application entities (AEs). The IN can be present in M2M server.

The IN communicates over a Mcc reference point with either:
one or more middle nodes; and/or
one or more application service nodes.

The IN may communicate with one or more ADNs over one or more Mca reference points.

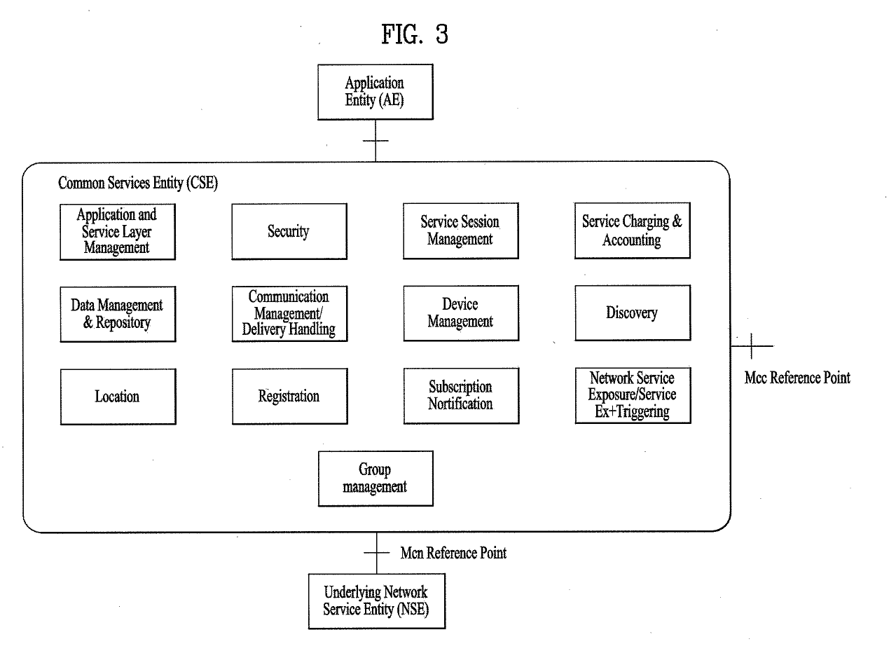

FIG. 3 illustrates M2M service functions in the M2M communication system.

M2M service functions (i.e. common service functions) provided by the oneM2M service framework include “Communication Management and Delivery Handling”, “Data Management and Repository”, “Device Management”, “Discovery”, “Group Management”, “Addressing and Identification”, “Location”, “Network Service Exposure, Service Execution and Triggering”, “Registration”, “Security”, “Service Charging and Accounting”, “Session Management” and “Subscription and Notification.”, as shown in FIG. 3.

A brief description will be given of each M2M service function.

Communication Management and Delivery Handling (CMDH): this provides communications with other CSEs, AEs and NSEs and delivers messages.

Data Management and Repository (DMR): this enables M2M applications to exchange and share data.

Device Management (DMG): this manages M2M devices/gateways. Specifically, the device management function includes installation and setting of applications, determination of set values, firmware update, logging, monitoring, diagnostics, topology management, etc.

Discovery (DIS): this discovers resources and information based on conditions.

Group Management (GMG): this processes a request related to a group that may be generated by grouping resources, M2M devices or gateways.

Addressing and Identification (AID): this identifies and addresses physical or logical resources.

Location (LOC): this enables M2M applications to obtain position information of an M2M device or gateway.

Network Service Exposure, Service Execution and Triggering (NSE): this enables communication of an underlying network and use of functions provided by the underlying network.

Registration (REG): this handles registration of an M2M application or another CSE with a specific CSE. Registration is performed in order to use M2M service functions of the specific CSE.

Security (SEC): this performs handling of sensitive data such as a security key, association establishment, authentication, authorization, identity protection, etc.

Service Charging and Accounting (SCA): this provides a charging function to CSEs.

Session Management (SM): this manages an M2M session for end-to-end communication.

Subscription and Notification (SUB): this notifies change of a specific resource when the change of the specific resource is subscribed.

The M2M service functions are provided through CSE, and AE(or, M2M applications) may use through Mca reference point, or other CSE may use the M2M service functions through Mcc reference point. Also, the M2M service functions may be operated synchronized with underlying network (or underlying network service entity (NSE) such as 3GPP, 3GPP2, Wi-Fi, Bluetooth).

All oneM2M devices/gateways/infrastructures do not have higher functions and may have mandatory functions and some optional functions from among the corresponding functions.

The term “resource” in the M2M communication system may be used to construct and express information in the M2M communication system, and may indicate all kinds of things capable of being identified by URI. The resource may be classified into a general resource, a virtual resource, and an announced resource. Respective resources can be defined as follows.

Virtual Resource: The virtual resource may trigger specific processing, and/or may perform retrieving of the result. The virtual resource is not permanently contained in CSE.

Announced Resource: The announced resource is a resource contained in the resource CSE connected to the announced (or notified) original resource. The announced resource may maintain some parts of the characteristics of the original resource. The resource announcement may facilitate the resource searching or discovery. The announced resource contained in the remote CSE is not present as a child of the original resource in the remote CSE, or may be used to generate child resources instead of the announced child of the original resource.

General resource: If this resource is not designated as the virtual or announced resource, the corresponding resource is a general resource.

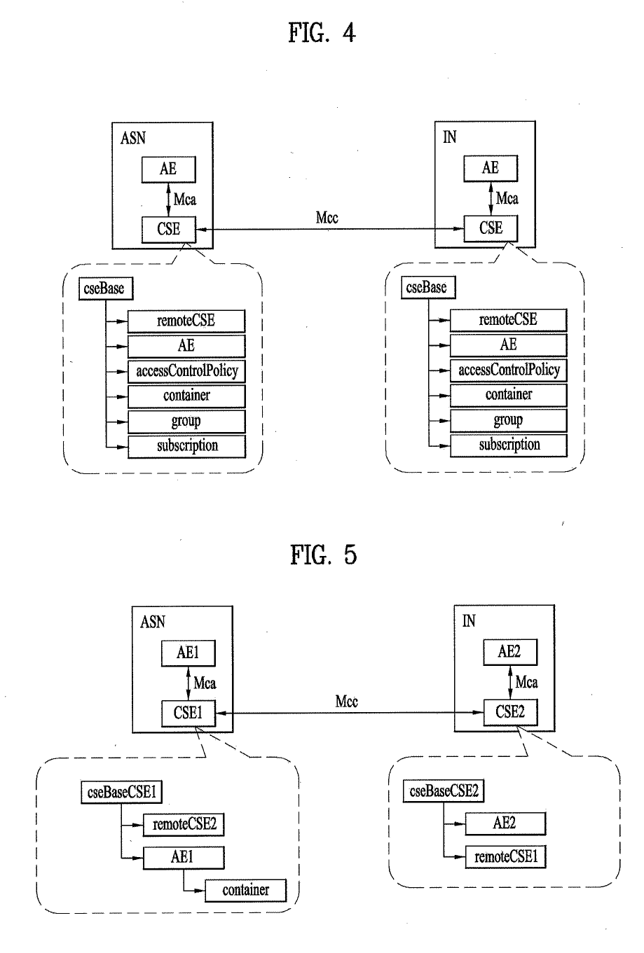

FIG. 4 illustrates structures of resources present in an M2M application service node and an M2M infrastructure node.

The M2M architecture defines various resources. M2M services for registering applications and reading sensor values can be performed by operating the resources. The resources are configured in one tree structure and may be logically connected to the CSE or stored in the CSE to be stored in M2M devices, M2M gateways, network domains and the like. Accordingly, the CSE can be referred to as an entity that manages resources. The resources have a <cseBase> as a tree root. Representative resources are described below.

<cseBase> resource: this is a root resource of oneM2M resources configured in a tree and includes all other resources.

<remoteCSE> resource: this belongs to <cseBase> resource and includes information on other CSE being connected or registered to corresponding CSE.

<AE> resource: this is a resource that is lower than <cseBase> or <remoteCSE> resource, and stores information on applications registered (connected) with the corresponding CSE when present under <cseBase> resource, and stores information on applications registered with other CSEs (in the name of CSE) when present under <remoteCSE> resource.

<accessControlPolicy> resource: this stores information associated with access rights to specific resources. Authentication is performed using access rights information included in this resource.

<container> resource: this is a resource that is lower than containers and stores data per CSE or AE.

<group> resource: this is a resource that is lower than groups and provides a function of grouping a plurality of resources and simultaneously processing the grouped resources.

<subscription> resource: this is a resource that is lower than subscriptions and executes a function of announcing a state change such as a resource value change through notification.

FIG. 5 illustrates structures of resources present in an M2M application service node (e.g. M2M device) and an M2M infrastructure node.

A description will be given of a method by which an AE (application 2) registered with the M2M infrastructure node reads a value of a sensor of the M2M device. The sensor refers to a physical device, in general. An AE (application 1) present in the M2M device reads a value from the sensor and stores the read value in the form of a container resource in a CSE (CSE 1) in which the AE (application 1) has registered. To this end, the AE present in the M2M device needs to be pre-registered with the CSE present in the M2M device. Upon completion of registration, registered M2M application related information is stored in the form of cseBaseCSE1/application1 resource, as shown in FIG. 5.

When the sensor value is stored, by the AE present in the M2M device, in a container resource lower than the cseBaseCSE1/application1 resource, the AE registered with the infrastructure node can access the corresponding value. To enable access, the AE registered with the infrastructure node also needs to be registered with a CSE (CSE 2) of the infrastructure node. Registration of the AE is performed by storing information about application 2 in cseBaseCSE2/application2 resource as application 1 is registered with CSE 1. Application 1 communicates with application 2 via CSE 1 and CSE 2 instead of directly communicating with application 2. To this end, CSE 1 needs to be pre-registered with CSE 2. When CSE 1 registers with CSE 2, CSE 1 related information (e.g. Link) is stored in the form of <remoteCSE> resource lower than cseBaseCSE2 resource. That is, <remoteCSE> provides a CSE type, access address (IP address and the like), CSE ID, and reachability information about the registered CSE.

Resource discovery refers to a process of discovering resources present in a remote CSE. Resource discovery is performed through a retrieve request and the retrieve request for resource discovery includes the following.

<startURI>: this indicates a URI. The URI can be used to limit the range of resources to be discovered. If <startURI> indicates a resource root <cseBase>, resource discovery is performed on all resources of a receiver that has received the retrieve request. The receiver performs resource discovery only on a resource indicated by <startURI> and a lower resource thereof.

filterCriteria: this information describes information related to a resource to be discovered. The receiver searches the resources within a discovery range defined by <startURI> for a resource that satisfies filterCriteria and transmits the resource to a requester of the corresponding request.

As shown in FIG. 4 or 5, the resource for use in the M2M system may be represented by a tree structure, and the root resource type may be denoted by <CSEBase>. Therefore, the <CSEBase> resource type must be present only when the common service entity (CSE) is present.

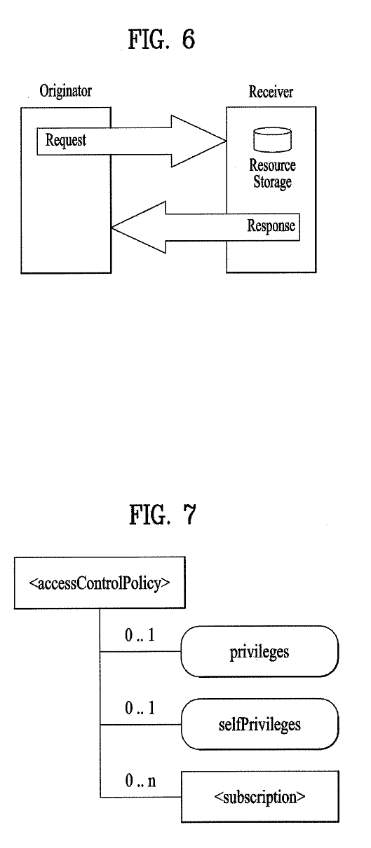

FIG. 6 is a conceptual diagram illustrating a general communication flow located at Mca and Mcc reference points. The M2M system operation is carried out on the basis of data exchanging. For example, in order to allow a first device to transmit or perform a command for stopping a specific operation of a second device, the first device must transmit the corresponding command (configured in a data form) to the second device. In the M2M system, data can be exchanged using the request and response messages during communication between the application (or CSE) and another CSE.

The request message may include the following information.
Operation: “Operation” means the shape of an operation to be carried out. (This information may be selected from among Create, Retrieve, Update, Delete, and Notify.)
To: “To” means an ID (i.e., ID of the receiver) of an entity scheduled to receive the request.
From: “From” means an ID of a calling user (i.e., call originator) who generates the request.
Request Identifier: “Request Identifier” means an ID (i.e., ID used to discriminate the request message) of the request message
Group Request Identifier parameter (identifier to prevent group fan-out request messages from being repeated)
Content: “Content” means content of resources to be transmitted.

The response message may include the following information. If the corresponding request message is successfully processed, the response message may include the following information.
To: “To” means an ID of a calling user (i.e., a call originator) who generates the request message.
From: “From” means an ID of a called person (i.e., a call receiver) who receives the request message.
Request Identifier: “Request Identifier” means an ID of the request message used to identify the ID of the request message.
Result contents: “Result contents” means the processed result (for example, Okay, Okay and Done, Okay and in progress) of the request message.
Content: “Content” means content of resources to be transmitted (only the resultant value (rs) can be transmitted.)

If the request message processing is failed, the response message may include the following information.
To: “To” means an ID of a calling user (i.e., a call originator) who generates the request message.
From: “From” means an ID of a called person (i.e., a call receiver) who receives the request message.
Request Identifier: “Request Identifier” means an ID of the request message (so as to identify the ID of the request message).
rs: “rs” means the processed result (for example, Not Okay) of the request message.

As described above, the response message may include the above-mentioned information.

Meanwhile, various resource types shown in the following table are present.

TABLE 1

| | | Child | |
|---|---|---|---|
| Resource | | Resource | Parent Resource |
| Type | Short Description | Types | Types |
| AE | Stores information about the AE. It is | subscription, | remoteCSE, CSEBase |
| | created as a result of successful | container, | |
| | registration of an AE with the registrar | group, | |
| | CSE. | accessControl | |
| | | Policy, | |
| | | mgmtObj, | |
| | | commCapabilities, | |
| | | pollingChannel | |
| cmdhNwAccessRule | Defines a rule for the usage of | schedule | cmdhNetworkAccessRules |
| | underlying networks. | subscription | |
| CSEBase | The structural root for all the resources | remoteCSE, | None |
| | that are residing on a CSE. It shall | node, | |
| | store information about the CSE itself. | application, | |
| | | container, | |
| | | group, | |
| | | accessControl | |
| | | Policy, | |
| | | subscription, | |
| | | mgmtObj, | |
| | | mgmtCmd, | |
| | | locationPolicy, | |
| | | statsConfig | |
| group | Stores information about resources of | fanOutPoint | Application, remoteCSE, |
| | the same type that need to be | subscription | CSEBase |
| | addressed as a Group. Operations | | |
| | addressed to a Group resource shall be | | |
| | executed in a bulk mode for all | | |
| | members belonging to the Group. | | |
| locationPolicy | Includes information to obtain and | subscription | CSEBase |
| | manage geographical location. It is | | |
| | only referred from container, the | | |
| | contentInstances of the container | | |
| | provides location information. | | |
| remoteCSE | Represents a remote CSE for which | application, | CSEBase |
| | there has been a registration procedure | container, | |
| | with the registrar CSE identified by | group, | |
| | the CSEBase resource. | accessControl | |
| | | Policy, | |
| | | subscription, | |
| | | mgmtObj, | |
| | | pollingChannel, | |
| | | node | |
| subscription | Subscription resource represents the | schedule | accessControlPolicy, |
| | subscription information related to a | | application, cmdhBuffer, |
| | resource. Such a resource shall be a | | cmdhDefaults, |
| | child resource for the subscribe-to | | cmdhEcDefParamValues, |
| | resource. | | cmdhDefEcValue, |
| | | | cmdhLimits, |
| | | | cmdhNetworkAccessRules, |
| | | | cmdhNwAccessRule, |
| | | | cmdhPolicy, container, |
| | | | CSEBase, delivery, |
| | | | eventConfig, |
| | | | execInstance, group, |
| | | | contentInstance, |
| | | | locationPolicy, |
| | | | mgmtCmd, mgmtObj, |
| | | | m2mServiceSubscription, |
| | | | node, nodeInfo, |
| | | | parameters, remoteCSE, |
| | | | request, schedule, |
| | | | statsCollect, statsConfig |
| container | Shares data instances among entities. | container, | application, container, |
| | Used as a mediator that takes care of | contentInstance, | remoteCSE, CSEBase |
| | buffering the data to exchange “data” | subscription | |
| | between AEs and/or CSEs. | | |
| contentInstance | Represents a data instance in the | subscription | container |
| | container resource. | | |

Each resource type may be located below the parent resource type of the corresponding resource type, and may have a child resource type. In addition, each resource type may have attributes, and actual values may be stored in the attributes.

Table 2 shows attributes of the <container> resource type. The attributes used to store the actual values may always be set to the value of 1 through multiplicity or may be selectively set to the values (‘0 . . . 1’) through multiplicity. In addition, the corresponding attributes may be established according to RO(Read Only), RW(Read and Write), WO(Write Only) according to characteristics generated when the corresponding attributes are generated.

TABLE 2

| Attributes of | | | |
|---|---|---|---|
| <container> | Multiplicity | RW/RO/WO | Description |
| resourceType | 1 | RO | Resource Type. This Write Once (at |
| | | | creation time then cannot be changed) |
| | | | resourceType attribute identifies the |
| | | | type of resources. Each resource shall |
| | | | have a resourceType attribute. |
| resourceID | 1 | RO | This attribute is an identifier for |
| | | | resource that is used for ‘non- |
| | | | hierarchical URI method’ or ‘IDs |
| | | | based method’ cases. |
| | | | This attribute shall be provided by the |
| | | | Hosting CSE when it accepts a |
| | | | resource creation procedure. The |
| | | | Hosting CSE shall assign a |
| | | | resourceID which is unique in the |
| | | | CSE. |
| parent ID | 1 | RO | The system shall assign the value to |
| | | | this attribute according to the |
| | | | parameters given in the CREATE |
| | | | Request. |
| | | | It establishes the parent-child |
| | | | relationship by identification of the |
| | | | parent of this child resource. Such |
| | | | identifier shall use the non- |
| | | | hierarchical URI representation. For |
| | | | example, an AE resource with the |
| | | | identifier “myAE1” which has been |
| | | | created under the resource |
| | | | “ . . . //example.com/oneM2M/myCSE”, |
| | | | the value of the parentID attribute |
| | | | will contain “ . . . //parentID”. |
| expirationTime | 1 | RW | Time/date after which the resource |
| | | | will be deleted by the hosting CSE. |
| | | | This attribute can be provided by the |
| | | | Originator, and in such a case it will |
| | | | be regarded as a hint to the hosting |
| | | | CSE on the lifetime of the resource. |
| | | | The hosting CSE can however decide |
| | | | on the real expirationTime. If the |
| | | | hosting CSE decides to change the |
| | | | expirationTime attribute value, this is |
| | | | communicated back to the Originator. |
| | | | The lifetime of the resource can be |
| | | | extended by providing a new value |
| | | | for this attribute in an UPDATE |
| | | | operation. Or by deleting the attribute |
| | | | value, e.g. by not providing the |
| | | | attribute when doing a full UPDATE, |
| | | | in which case the hosting CSE can |
| | | | decide on a new value. |
| | | | This attribute shall be mandatory. If |
| | | | the Originator does not provide a |
| | | | value in the CREATE operation the |
| | | | system shall assign an appropriate |
| | | | value depending on its local policies |
| | | | and/or M2M service subscription |
| | | | agreements. |
| accessControlPolicyIDs | 0 . . . 1 (L) | RW | The attribute contains a list of |
| | | | identifiers (either an ID or a URI |
| | | | depending if it is a local resource or |
| | | | not) of an <accessControlPolicy> |
| | | | resource. The privileges defined in |
| | | | the <accessControlPolicy> resource |
| | | | that are referenced determine who is |
| | | | allowed to access the resource |
| | | | containing this attribute for a specific |
| | | | purpose (e.g. Retrieve, Update, |
| | | | Delete, etc.). |
| labels | 0 . . . 1 | WR | Tokens used as keys for discovering |
| | | | resources. |
| | | | This attribute is optional and if not |
| | | | present it means that the resource |
| | | | cannot be found by means of |
| | | | discovery procedure which uses |
| | | | labels as key parameter of the |
| | | | discovery. |
| creationTime | 1 | RO | Time/date of creation of the resource. |
| | | | This attribute is mandatory for all |
| | | | resources and the value is assigned by |
| | | | the system at the time when the |
| | | | resource is locally created. Such an |
| | | | attribute cannot be changed. |
| creator | 0 . . . 1 | RO | The AE-ID or CSE-ID of the entity |
| | | | which created the resource. |
| lastModifiedTime | 1 | RO | Last modification time/date of the |
| | | | resource. |
| | | | This attribute shall be mandatory and |
| | | | its value is assigned automatically by |
| | | | the system each time that the |
| | | | addressed target resource is modified |
| | | | by means of the UPDATE operation. |
| stateTag | 1 | RO | An incremental counter of |
| | | | modification on the resource. When a |
| | | | resource is created, this counter is set |
| | | | to 0, and it will be incremented on |
| | | | every modification of the resource. |
| | | | The stateTag attribute of the parent |
| | | | resource should be incremented first |
| | | | and copied into this stateTag attribute |
| | | | when a new instance is added to the |
| | | | parent resource. |
| announceTo | 0 . . . 1 | RW | This attribute may be included in a |
| | | | CREATE or UPDATE Request in |
| | | | which case it contains a list of |
| | | | URIs/CSE-IDs which the resource |
| | | | being created/updated shall be |
| | | | announced to. |
| | | | This attribute shall only be present on |
| | | | the original resource if it has been |
| | | | successfully announced to other |
| | | | CSEs. This attribute maintains the list |
| | | | of URIs to the successfully |
| | | | announced resources. Updates on this |
| | | | attribute will trigger new resource |
| | | | announcement or de-announcement. |
| announcedAttribute | 0 . . . 1 | RW | This attributes shall only be present |
| | | | on the original resource if some |
| | | | Optional Announced (OA) type |
| | | | attributes have been announced to |
| | | | other CSEs. This attribute maintains |
| | | | the list of the announced Optional |
| | | | Attributes (OA type attributes) in the |
| | | | original resource. Updates to this |
| | | | attribute will trigger new attribute |
| | | | announcement if a new attribute is |
| | | | added or de-announcement if the |
| | | | existing attribute is removed.) |
| maxNrOfInstances | 0 . . . 1 | RW | Maximum number of instances of |
| | | | <contentInstance> child resources. |
| maxByteSize | 0 . . . 1 | RW | Maximum number of bytes that are |
| | | | allocated for a <container> resource |
| | | | for all instances in the <container> |
| | | | resource. |
| maxInstanceAge | 0 . . . 1 | RW | Maximum age of the instances of |
| | | | <contentInstance> resources within |
| | | | the <container>. The value is |
| | | | expressed in seconds. |
| currentNrOfInstances | 1 | RO | Current number of instances in a |
| | | | <container> resource. It is limited by |
| | | | the maxNrOfInstances. |
| currentByteSize | 1 | RO | Current size in bytes of data stored in |
| | | | a <container> resource. It is limited |
| | | | by the maxNrOfBytes. |
| latest | 0 . . . 1 | RO | Reference to latest <contentInstance> |
| | | | resource, when present. |
| locationID | 0 . . . 1 | RW | URI of the resource where the |
| | | | attributes/policies that define how |
| | | | location information are obtained and |
| | | | managed. This attribute is defined |
| | | | only when the <container> resource is |
| | | | used for containing location |
| | | | information. |
| ontologyRef | 0 . . . 1 | RW | A URI of the ontology used to |
| | | | represent the information that is |
| | | | managed and understood by the AE. |
| | | | The ontology refers to a specification |
| | | | in which terms and relationship |
| | | | therebetween used in a domain to be |
| | | | handled. |

Resource Access Control Policy

An access control policy is defined as a “white list” or privileges and each privilege defines “allowed” entities for certain access modes. Sets of privileges are handled such that the resulting privileges for a group of privileges are the sum of the individual privileges; i.e., an action is permitted if the action is permitted by some/any privilege in the set. A selfPrivilege attribute lists entities authorized for Read/Update/Delete of <accessControlPolicy> resource.

All privileges defined by the access control policy are associated with positions, time windows and IP addresses.

Privileges for accessing a resource are defined by privileges defined in <accessControlPolicy> resource by setting an accessControlPolicyID attribute on the resource.

FIG. 7 illustrates a structure of the <accessControlPolicy> resource. The following table shows attributes of the <accessControlPolicy> resource.

TABLE 3

| | | RW/ | |
|---|---|---|---|
| Attribute Name of | | RO/ | |
| <accessControlPolicy> | Multiplicity | WO | Description |
| resourceType (rT) | 1 | RO | Refer to Table 2 |
| parentID (pID) | 1 | RO | Refer to Table 2 |
| expirationTime (eT) | 1 | RW | Refer to Table 2 |
| labels (lBs) | 0 . . . 1 | RW | Refer to Table 2 |
| creationTime (cT) | 1 | RO | Refer to Table 2 |
| lastModifiedTime | 1 | RO | Refer to Table 2 |
| (lMT) | | | |
| Link | 1 | WO | This attribute shall be present only on the |
| | | | announced resource. This attribute shall |
| | | | provide the link (URI) to the original |
| | | | resource. This is only for |
| | | | <accessControlPolicyAnnc>. |
| announceTo | 1 | RW | Refer to Table 2 |
| announcedAttribute | 1 | RW | This attributes shall only be present on |
| | | | the original resource if some Optional |
| | | | Announced (OA) type attributes have |
| | | | been announced to other CSEs. This |
| | | | attribute maintains the list of the |
| | | | announced Optional Attributes (OA type |
| | | | attributes) in the original resource. |
| | | | Updates to this attribute will trigger new |
| | | | attribute announcement if a new attribute |
| | | | is added or de-announcement if the |
| | | | existing attribute is removed. |
| privileges (ps) | 1 | RW | The list of privileges defined by this |
| | | | <accessControlPolicy> resource. These |
| | | | privileges are applied to resources |
| | | | referencing this <accessControlPolicy> |
| | | | resource using the accessControlPolicyID |
| | | | attribute. |
| selfPrivileges (sP) | 1 | RW | Defines the list of privileges for the |
| | | | <accessControlPolicy> resource itself. |

Privileges can be generalized to actions (which may be granting access, but may also be more specific, granting access, i.e. filtering part of data). While the privileges can be generalized to conditions, which may include the identifier of a requestor, except specified identifiers, but the privileges may also include time based conditions.

An access authentication mechanism based on the access control policy operates by matching a requester to the privilege of the requester, stored in the <accessControlPolicy> resource. Upon discovery of positive matching, a requested operation (e.g. RETRIEVE) is checked using a set of allowed operations associated with a matching privilege owner. If the check fails, the request is rejected. Such set is referred to as a privilege flag.

Self-privileges and privileges are lists of requester privileges associated with the <accessControlPolicy> resource itself and privilege flags applied to the <accessControlPolicy> resource and all other resource types which address accessControlPolicyID common attribute.

All privileges defined in the access control policy are associated with positions, time windows and IP addresses prior to access authentication.

Each privilege of the self-privileges and privileges can be configured as a role. Such role is identified by a role name and a URL that addresses an M2M service subscription resource in which the role is defined. When a requester represents itself with a specific role, the access control policy operates by matching the requester with lists, which belong to a specific role specified in the M2M service subscription resource.

Each privilege in the privilege and self-privilege lists includes the following elements.

TABLE 4

| Name | Description |
|---|---|
| originatorPrivileges | Refer to Table 5 |
| Contexts | Refer to Table 6 |
| operationFlags | Refer to Table 7 |

“originatorPrivileges” includes information shown in the following table.

TABLE 5

| Name | Description |
|---|---|
| Domain | FQDN domain |
| Originator | CSE ID or AE ID which represent a originator |
| identifier | identity |
| Token | Access token usually provided as query |
| | parameter |
| All | All originators |
| Role | A role name associated with the URL the a |
| | Service Subscription resource where such role |
| | is defined |

“contexts” in Table 4 includes information shown in the following table.

TABLE 6

| Name | Description |
|---|---|
| Context | Defines the context in which every privileges |
| | of the present access control policy resource |
| | applies, e.g. time windows, location, and IP |
| | address. |

“operationFlags” in Table 4 includes information shown in the following table.

TABLE 7

| Name | Description |
|---|---|
| RETRIEVE | Privilege to retrieve the content of an |
| | addressed resource |
| CREATE | Privilege to create a child resource |
| UPDATE | Privilege to update the content of an addressed |
| | resource |
| DELETE | Privilege to delete an addressed resource |
| DISCOVER | Privilege to discover the resource |
| NOTIFY | Privilege to receive a notification |

In an M2M communication system, an access control policy resource is stored separately from a resource to which the corresponding access control policy has been applied. The resource to which the access control policy has been applied has only AccessRightID (URI of the access control policy resource) of the access control policy resource. Accordingly, if an M2M entity wants to check an access control policy of a specific resource, the M2M entity needs to refer to AccessRightID.

Entity Registration

An M2M entity finishes preparation for using systems/services by registering with neighboring entities irrespective of whether the M2M entity is located in the field domain or infrastructure domain. Such registration is performed at the request of a registree and information on the registree is stored in a registrar as a registration result.

After registration, oneM2M entities can use M2M services using common functions provided by a CSE, as illustrated in FIG. 3.

oneM2M entities include an AE and a CSE and thus registration may be divided into AE registration and CSE registration. Here, both the AE and CSE refer to registrees and the CSE corresponds to a registrar. In the case of CSE registration, information on the registrar CSE is additionally stored in the registree CSE.

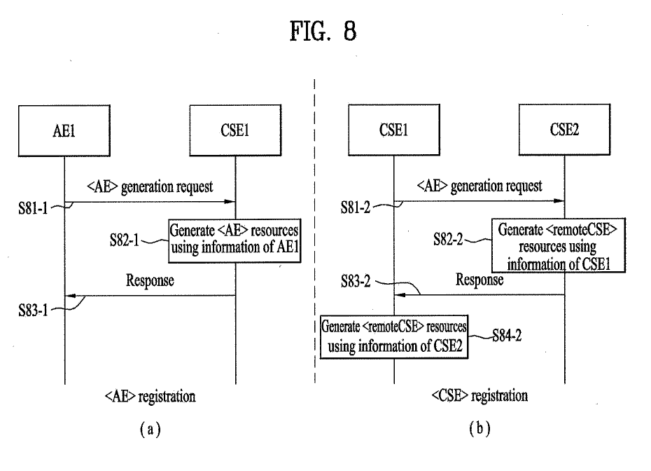

FIG. 8 illustrates an AE registration procedure and a CSE registration procedure. FIG. 8(a) shows the AE registration procedure. AE1 that intends to perform registration sends a request for generation of <AE> resources to CSE1 corresponding to a registrar (S81-1). CSE1 can generate the <AE> resources using information of AE1 (S82-2). Then, CSE1 can send a response including a result of registration to AE1 (S83-2).

FIG. 8(b) illustrates the CSE registration procedure. The procedure of FIG. 8(b) corresponds to the procedure of FIG. 8(a) except that CSE1 corresponds to a registree, CSE2 corresponds to a registrar, and when CSE2 sends a result for a registration request of CSE1 (S83-2), CSE1 generates <remoteCSE> resources using information of CSE2 (S84-2).

<Description of Resource Announcement>

Hereinafter, resource announcement technology will be described. Resource announcement refers to notifying or informing another CSE of the presence of a specific resource, more simply, a procedure of creating a resource possessed by a specific CSE (i.e., an original resource) by another CSE in the form of an announced resource. The announced resource provides only limited information about the original resource, such as a uniform resource identifier (URI) and a label attribute of the original resource.

An original resource present at a specific CSE may be announced to a remote CSE to inform the remote CSE of the presence of the resource. Resource announcement facilitates resource discovery because an original resource hosting CSE having a specific resource (e.g., an original resource) may inform a remote CSE interested in the specific resource of the presence of the specific resource, without the need for the remote CSE to perform resource discovery with respect to a wide range of CSEs. Basically, the announced resource contains only limited information about the original resource, such as URI information (i.e., a link attribute) about the original resource and a label attribute of the original resource.

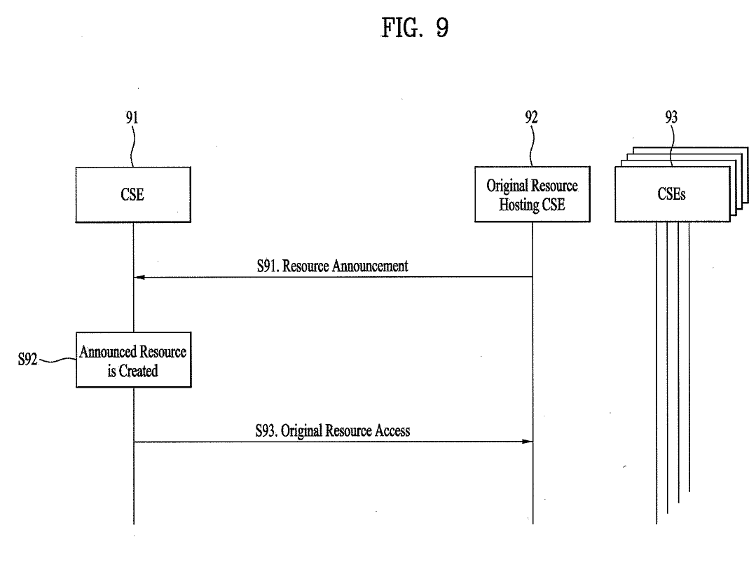

FIG. 9 illustrates a resource announcement procedure. A CSE 92 having a specific resource (e.g., an original resource) informs a remote CSE 91 of the presence of the specific resource through resource announcement (S91). Resource announcement to the remote CSE 91 causes the remote CSE to create an announced resource (S92). Because the announced resource basically provides link information about the original resource, the remote CSE 91 may easily know where the original resource having specific information is present and access the original resource S93, to thereby use a service provided by the original resource.

If the specific original resource is deleted after being announced to the remote CSE, all announced resources should also be deleted. If an announced resource remains undeleted, the announced resource causes a problem because it provides information about an absent original resource. If an announced resource is not deleted promptly upon deletion of the original resource (because the CSE 91 having the announced resource is not reachable), the announced resource may be deleted later by the CSE 92 having the original resource or by expiration of the announced resource according to an “expirationTime” attribute assigned to the announced resource. For this purpose, in the case where the original resource is announced, the original resource has a list of URIs (announceTo attribute) of announced resources.

An announced resource created by resource announcement includes a URI address of an original resource residing on another CSE. Although the announced resource is a real resource (not a virtual resource) having a separate resource type, the announced resource basically has a link attribute that stores a URI indicating the original resource and characteristically has limited attributes. For example, while a <container> resource has an <instance> resource as a child resource to store data and the <instance> resource has a content attribute, an announced resource <containerAnnc> for the <container> resource simply provides URI information about the original resource through a link attribute, without directly storing data (without requiring the <instance> resource and the content attribute of the <instance> resource). If other information about the original resource is further required, it is necessary to directly access the original resource through the URI of the original resource provided by the announced resource. Resource announcement for the original resource is performed only by an original resource hosting CSE having the original resource.

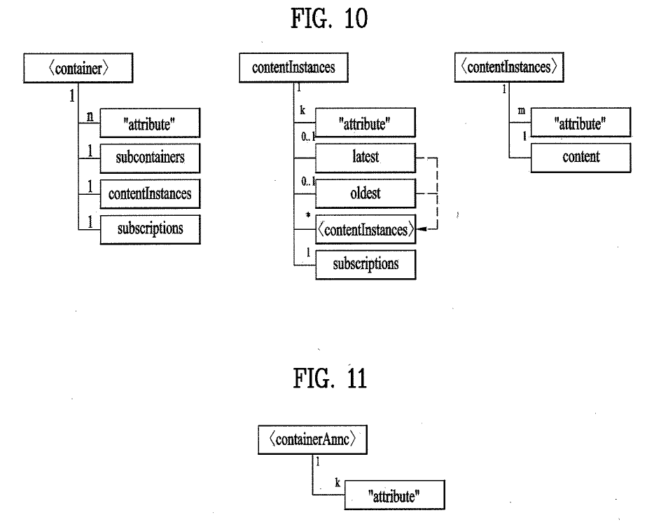

FIGS. 10 and 11 illustrate a <container> resource and a <containerAnnc> resource.

An announced resource basically has a link attribute and stores the URI of an original resource in the link attribute. Even though an attribute of the original resource is mandatory, the announced resource may not have the attribute. Also, according to the foregoing conventional technology, the announced resource always has predetermined attributes. For example, an announced resource type <containerAnnc> of the <container> resource has the following attributes.

TABLE 8

| | | RW/ | |
|---|---|---|---|
| Attribute Name of | | RO/ | |
| <container> | Multiplicity | WO | Description |
| ResourceType (rT) | 1 | RO | Refer to Table 2 |
| parentID (pID) | 1 | RO | Refer to Table 2 |
| expirationTime | 1 | RW | Refer to Table 2 |
| Link | 1 | WO | Refer to Table 3 |
| accessRightID | 1 | RW | Refer to Table 2 |
| Labels | 1 | RW | Refer to Table 2 |

Therefore, to obtain information such as a ‘currentNrOfInstances’ attribute and an ‘ontologyRef’ attribute present in the original resource, the original resource should be directly accessed because <containerAnnc> does not have these attributes.

If the announced resource is capable of directly providing information about attributes of the original resource, it is more efficient because there is no need for directly accessing the original resource. For example, if the <containerAnnc> resource has an ‘ontologyRef’ attribute and the ‘ontologyRef’ attribute has the same value as the ‘ontologyRef’ attribute of the original resource, information may be acquired directly from the ‘ontologyRef’ attribute of the announced resource without accessing the original resource. In this manner, an attribute of the original resource may be announced to the announced resource. This is called attribute announcement.

However, if all attributes of the original resource are announced to the announced resource, the resulting announcement of unnecessary attributes may cause overhead. Accordingly, only necessary attributes should be announced. Different attributes may require attribute announcement under circumstances despite the same resource type. Therefore, the present invention also provides a method for classifying the attributes of an original resource into the following three types.
MA (Mandatory Announced): The attribute in the original resource is announced to the announced resource. The content of such an announced attribute is the same as the original attribute.
OA (Optional Announced): The attribute in the original resource may be announced to the announced resource depending on the contents of an ‘announcedAttribute’ attribute in the original resource. The contents of such an announced attribute is the same as the contents of the original attribute.
NA (Not Announced): The original attribute is not announced to the announced resource.

An attribute marked with OA may be announced selectively using an ‘announcedAttribute’ attribute. The ‘announcedAttribute’ attribute will be described below. The ‘announcedAttribute’ attribute is always present in an announce-able original resource.

‘announcedAttribute’ attribute: If some OA attributes are announced to other CSEs, this attribute is present in the original resource. The ‘announcedAttribute’ attribute includes a list of announced OA attributes in the original resource. Update of the ‘announcedAttribute’ attribute may trigger new attribute announcement in the case of adding a new attribute or attribute de-announcement in the case of deleting an existing attribute.

For example, each attribute of the <container> resource may be marked with MA/OA/NA as follows. As mentioned before, an attribute marked with MA is necessarily announced to an announced resource and thus present in the announced resource. An attribute marked with NA should not be present in the announced resource. An attribute marked with OA may be present in the announced resource depending on the announcedAttribute attribute.

[Table 2] may be given as follows according to the type (MA, OA, or NA) of the original resource.

TABLE 9

| | | RW/ | | |
|---|---|---|---|---|
| Attribute Name of | | RO/ | | <containerAnnc> |
| <containerAnnc> | Multiplicity | WO | Description | Attributes |
| resourceType | 1 | RO | Same as Table 1 | NA |
| resourceID | 1 | WO | Same as Table 1 | NA |
| parentID | 1 | RO | Same as Table 1 | NA |
| expirationTime | 1 | RW | Same as Table 1 | MA |
| accessControlPolicy | 0 . . . 1 | RW | Same as Table 1 | MA |
| IDs | (L) | | | |
| labels | 0 . . . 1 | WR | Same as Table 1 | MA |
| creationTime | 1 | RO | Same as Table 1 | NA |
| creator | 1 | RO | Same as Table 1 | NA |
| lastModifiedTime | 1 | RO | Same as Table 1 | NA |
| stateTag | 1 | RO | Same as Table 1 | OA |
| announceTo | 1 | RW | Same as Table 1 | NA |
| announcedAttribute | 1 | RW | Same as Table 1 | NA |
| maxNrOfInstances | 0 . . . 1 | RW | Same as Table 1 | OA |
| maxByteSize | 0 . . . 1 | RW | Same as Table 1 | OA |
| maxInstanceAge | 0 . . . 1 | RW | Same as Table 1 | OA |
| currentNrOfInstances | 1 | RO | Same as Table 1 | OA |
| currentByteSize | 1 | RO | Same as Table 1 | OA |
| latest | 0 . . . 1 | RO | Same as Table 1 | OA |
| locationID | 0 . . . 1 | RW | Same as Table 1 | OA |
| ontologyRef | 0 . . . 1 | RW | Same as Table 1 | OA |

In legacy resource announcement, an access control privilege for an announced resource and an access control privilege for an original resource are identically applied, thereby causing a third entity having a privilege to access the original resource to directly request update or deletion of the announced resource. Therefore, a synchronization problem between both resources (i.e., the original resource and the announced resource) may be created and there is a possibility of being used for malicious purposes.

In addition, in legacy resource announcement, because criteria for setting access modes (WO/RW/RO) of an announced attribute according to an original attribute is not specified, it is necessary to define the criteria. Multiple combinations may be set for the access modes of the announced attribute corresponding to the access modes of the original attribute. However, a specific combination may not support necessary synchronization between the original attribute and the announced attribute.

For reference, three access modes of attributes are as follows.

Read/Write (RW): RW indicates a value of an attribute which is set when a resource is created or updated based on information (i.e., a content parameter) from an originator. Such attributes are allowed for Create/Update/Retrieve/Delete/Notify operations.

Read Only (RO): RO indicates a value of an attribute which is internally set by a hosting CSE. Such an attribute is allowed only for a Retrieve operation.

Write Once (WO): WO indicates a value of an attribute which is set when a resource is created based on information (i.e., a content parameter) from an originator. Such an attribute is allowed for a Retrieve operation after creation.

The following table indicates access modes of an announced attribute for all mappable cases with access modes of an original attribute and specifies features according to each combination.

TABLE 10

| | | Announced Attribute | | |
|---|---|---|---|---|
| | | RO | WO | RW |
| Original | RO | Inapplicable | Applicable (The | Applicable (The announced |
| Attribute | | (The announced | announced attribute can | attribute can be corrected when |
| | | attribute cannot | be changed once when the | the original attribute is changed. |
| | | be corrected when | original attribute is | Because another entity can change |
| | | the original | changed. The announced | even attributes that only an |
| | | attribute is | attribute is applicable to a | original attribute hosting CSE can |
| | | changed.) | specific attribute. E.g., | change or cannot change, |
| | | | resourceID) | maintenance of synchronization is |
| | | | | difficult. E.g., stateTag attribute) |
| | WO | Applicable (The | Applicable (The | Inapplicable (An RW attribute |
| | | announced | announced attribute can | cannot be corrected because even |
| | | attribute is | be changed by a one-time | the original attribute is not |
| | | applicable if it is | request when the | changed except for first creation.) |
| | | transmitted by a | announced attribute is | |
| | | request | created. E.g., | |
| | | parameter.) | resourceName) | |
| | RW | Inapplicable | Inapplicable (The | Applicable (Maintenance of |
| | | (The announced | announced attribute can | synchronization is difficult |
| | | attribute cannot | be corrected only once | because only the announced |
| | | be corrected when | when the original attribute | attribute is changed and the |
| | | the original | is changed.) | original attribute is not changed |
| | | attribute is | | when another privileged entity |
| | | changed.) | | requests change of an attribute.) |

Among applicable cases of the above possible combinations, the following two combinations have difficulty in adjusting synchronization between the original attribute and the announced attribute.

A. Original attribute: RO (attribute cannot be corrected), announced attribute: RW

B. Original attribute: RW (attribute can be corrected), announced attribute: RW

In the case of A, since an external entity may make a request for change and deletion of the announced attribute, a technique capable of preventing random change and deletion by controlling a privilege of the external entity is needed. In the case of B, a method of enabling change of the original attribute when the announced attribute is changed needs to be added to the prior art.

The present invention proposes a method of solving the above-described problems of the prior art and restricting an access control privilege for an announced resource of a third requester to support synchronization between an original attribute and the announced attribute on the premise that synchronization between the original attribute and the announced attribute should be maintained and a method of maintaining synchronization by preventing access of a third party according to an access mode of an attribute or by changing the original attribute as well.

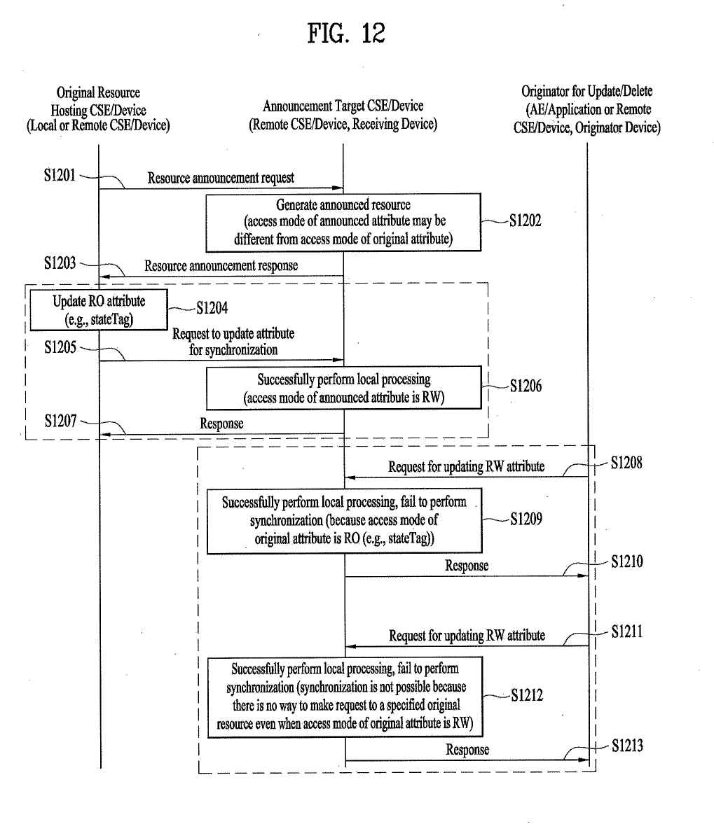

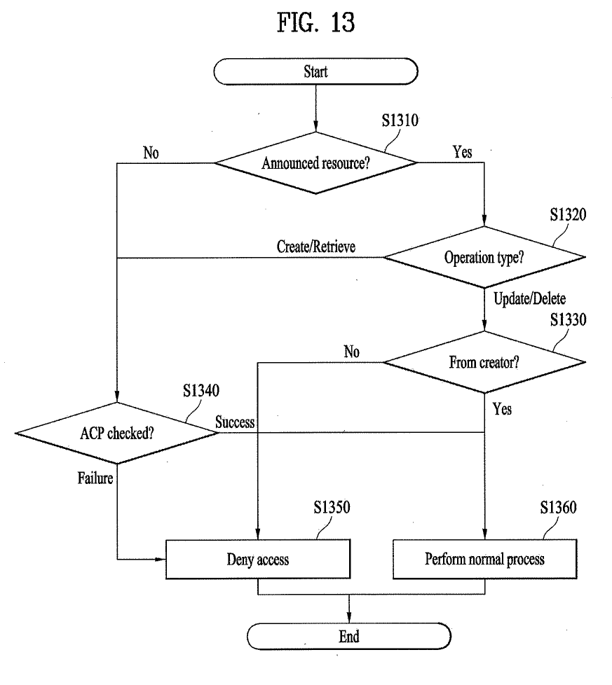

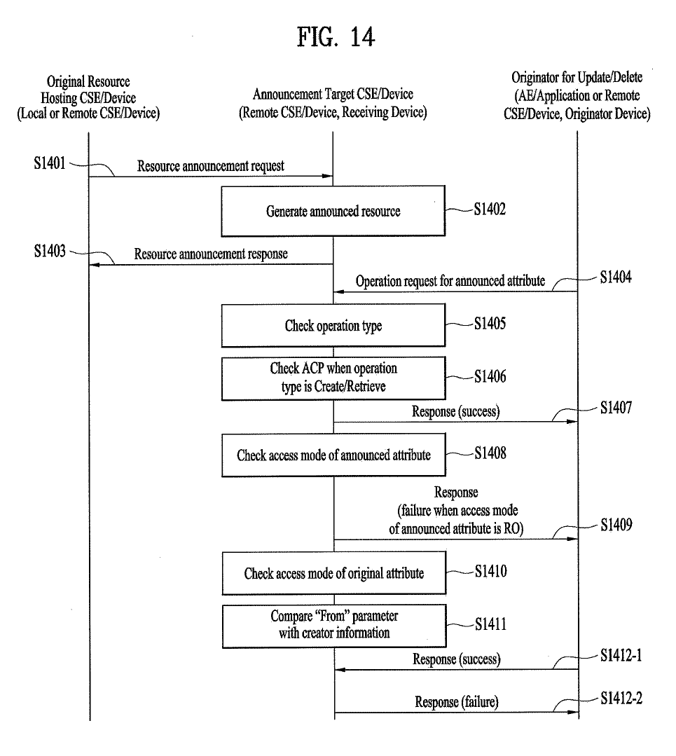

FIG. 12 illustrates an entire procedure related to embodiments of the present invention. In steps S1201 to S1203, an original resource hosting CSE or device creates an announced resource through a resource announcement procedure. Steps S1204 to S1207 will be described in more detail with reference to FIG. 13. Steps S1208 to S1210 and steps S1211 to S1213 will be described with reference to FIGS. 14, 15, and 16.

FIG. 13 illustrates a method of restricting an access control privilege for an announced resource. A procedure according to FIG. 13 is performed by an entity having the announced resource (e.g., “CSE”, hereinafter, referred to as a “receiving device”).

The receiving device receives a request from an originator device. The receiving device may determine whether a target of the request is an original resource or an announced resource (S1310). If the target of the request is the announced resource, the receiving device may check an operation type of the request (S1320). If the operation type of the request is Create/Retrieve, the receiving device may check an access privilege by applying an access control policy (ACP) (S1340). If the target of the request is the original resource, the receiving device may check the access privilege by applying the ACP. If the originator device has a privilege to access the corresponding resource, the receiving device may process the request (S1360). If the originator device has no privilege to access the corresponding resource, the receiving device may deny the request (S1350).

If the operation type of the request is Update/Delete, the receiving device may determine whether the originator device is a creator of the target (S1330) by comparing a “From” parameter of the request (message) with a link attribute of the announced resource. The value of the “From” parameter is an ID of an original resource hosting CSE, i.e., a CSE-ID, and the value of the link attribute of the announced resource is a resource ID of the original resource. If the resource ID is a service provider (SP)-relative resource ID, since the link attribute includes the CSE-ID, the link attribute may be compared with the “From” parameter. As a result of comparison, if the originator device is the creator of the announced resource, the receiving device performs step S1360 and, otherwise, the receiving device performs step S1350.

The receiving device performs steps S1350 and S1360 and may transmit a corresponding response message to the originator device.

FIG. 14 illustrates a procedure for a method of maintaining synchronization between an original attribute and an announced attribute by restricting an access control privilege of a requester according to an embodiment of the present invention.

Even when an access mode of the original attribute is RO, since information update is needed to maintain synchronization, an access mode of the announced attribute may be RW in some cases. Then, any device having an access control privilege, although the device is not an original resource hosting CSE or device, may request an operation for the announced attribute.

The receiving device may receive a resource announcement request from the original resource hosting CSE or device (S1401). The receiving device may generate the announced resource according to the request (S1402). Then, the receiving device may transmit a response to the resource announcement request to the original resource hosting CSE or device (S1403).

The receiving device may receive an operation request for the announced resource, for example, an operation request for a specific announced attribute, from the originator device (S1404). The receiving device may check an operation type of the operation request (S1405). Since an operation request for Retrieve and Create has no relation to an access mode of an attribute, the receiving device checks only an ACP with respect to Retrieve and Create operations (S1406). If the originator device has a privilege to access the corresponding resource, the receiving device performs a related operation and ends the procedure (S1407). On the other hand, for an Update or Delete request, the receiving device performs an operation for maintaining synchronization according to an access mode of the requested attribute.

If the operation type is Update or Delete, the receiving device may check an access mode of the announced attribute (S1408). If the access mode of the announced attribute is RO, since it is impossible to change or delete the announced attribute, the receiving device may deny the request (S1409).

If the access mode of the announced attribute is RW, the receiving device may check an access mode of the original attribute (S1410). If the access mode of the announced attribute is RW and the access mode of the original attribute is RO, the receiving device may check whether the originator device is identical to a creator of the announced resource (S1411). As described earlier, step S1411 may be performed based on a “From” parameter of the request and a link attribute of the announced resource.

If the originator device is identical to the creator of the announced resource, the receiving device may perform a requested operation and transmit a response to the request to the originator device (S1412-1). If the originator device is not identical to the creator of the announced resource, the receiving device restricts an Update or Delete privilege of the announced attribute even though the originator device has an access control privilege for the original resource. That is, the receiving device may transmit a failure response to the request to the originator device (S1412-2).

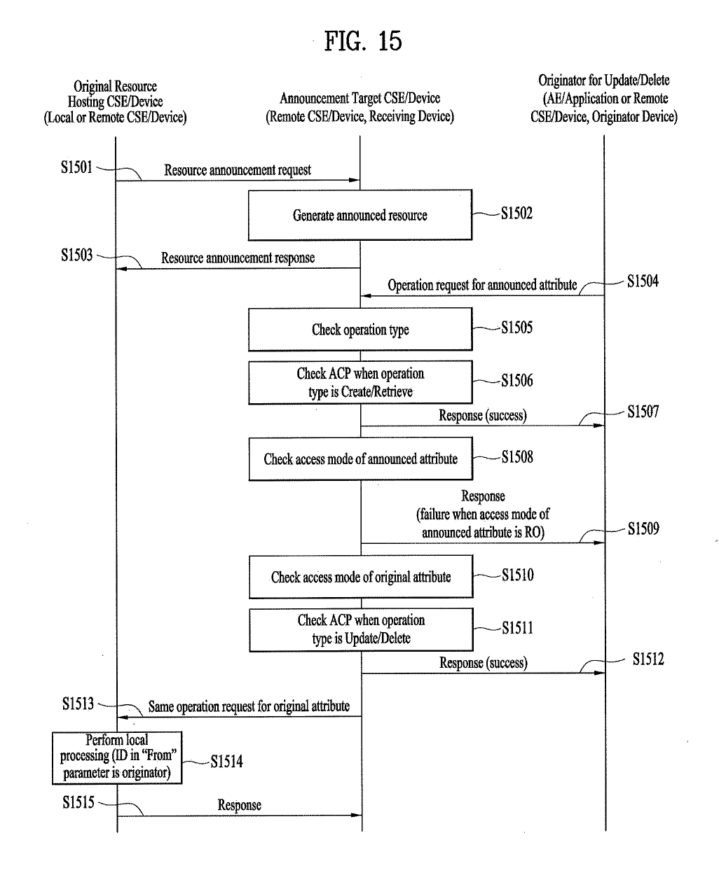

FIG. 15 is a procedure for a method of maintaining synchronization between an original attribute and an announced attribute by transmitting the same request to an original resource hosting CSE when an entity or device having a privilege requests change and deletion of the announced attribute according to an embodiment of the present invention.

Since steps S1501 to S1510 of FIG. 15 are identical to steps S1401 to S1410 of FIG. 14, steps S1501 to S1510 may refer to FIG. 14.

If an access mode of the announced attribute is RW and an access mode of the original attribute is RW, the receiving device may determine whether the originator device has an access control privilege for the original resource according to an ACP (i.e., <accessContolPolicy> resource) (S1511). After authenticating the access control privilege for the original resource, the receiving device may perform an operation according to the request. The receiving device may update or delete the announced attribute according to the request. If it is determined that the originator device has the access control privilege for the original resource, the receiving device may respond with a success message (S1512). The receiving device may transmit the request to the original resource hosting CSE or device for synchronization between the original attribute and the announced attribute (S1513). Although the originator device (requester) has actually requested that the receiving device change or delete the announced attribute and this request has been transmitted to the original resource hosting CSE or device to request change or deletion of the announced attribute, a CSE-ID of the originator device is written in a “From” parameter of the request transmitted in step S1513. Therefore, the original resource hosting CSE or device may recognize that the originator device has directly made the request and may perform a corresponding operation (S1514). It is assumed that the originator device has an access privilege for the original resource. The original resource hosting CSE or device may transmit a response to the request to the receiving device (S1515).

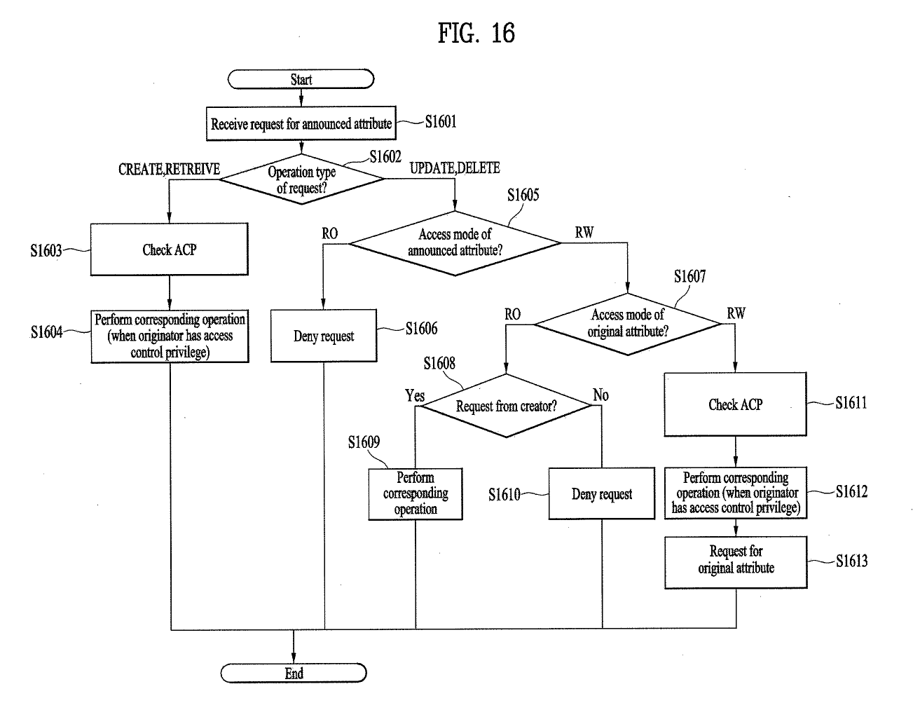

FIG. 16 illustrates a procedure for a method of maintaining synchronization between an original attribute and an announced attribute according to a requested operation and an access mode of an attribute based on a description given with reference to FIGS. 14 and 15.

The receiving device may receive a request for an announced resource from an originator device (S1601). The receiving device may check an operation type of the request to distinguish between a Create/Retrieve request and an Update/Delete request (S1602).

If the operation type is Create/Retrieve, the receiving device may determine whether the request is made by an entity or device having an access control privilege for an original resource (S1603). Step S1603 may be performed using an <accessControlPolicy> resource of the original attribute. If it is determined that the originator device has the access control privilege for the original resource, the receiving device may perform a Create/Retrieve operation and respond to the request (S1604).

If the operation type is Update/Delete, the receiving device may check an access mode of the announced attribute to determine whether the access mode of the announced attribute is RO or RW (S1605).

If the access mode of the announced attribute is RO, the receiving device may deny the request because the announced attribute cannot be updated or deleted (S1606).

If the access mode of the announced attribute is RW, the receiving device may check an access mode of the original attribute to determine whether the access mode of the original attribute is RO or RW (S1607).

If the access mode of the original attribute is RO, the receiving device may determine whether the request is generated from a creator of the announced resource or attribute (S1608). That is, the receiving device may determine whether the originator device is the creator of the announced resource or attribute.

If the originator device is the creator of the announced resource or attribute, the receiving device may perform a requested Update/Delete operation and respond to the request (S1609). If the originator device is not the creator of the announced resource or attribute, the receiving device may deny the request regardless of whether the access control privilege is valid (S1610).

If the access mode of the original attribute is RW, the receiving device may determine whether the request is made by an entity or device having the access control privilege for the original resource (S1611). Step S1611 may be performed using an <accessControlPolicy> resource of the original attribute. If the request is made by the entity or device having the access control privilege for the original resource, the receiving device may perform a requested Update/Delete operation and respond to the request (S1612). If the request is not made by the entity or device having the access control privilege for the original resource, the receiving device may deny the request. Additionally, the receiving device may transmit the same request to the original resource hosting CSE or device to maintain synchronization between the announced attribute and the original attribute (S1613).

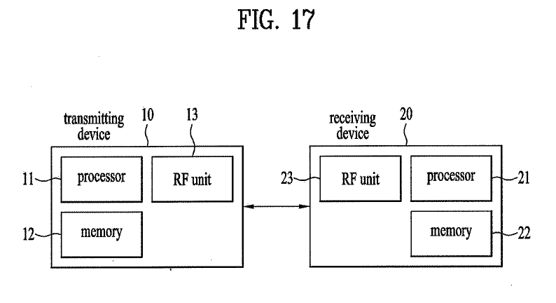

FIG. 17 is a block diagram of a transmitting device 10 and a receiving device 20 configured to implement exemplary embodiments of the present invention. Referring to FIG. 17, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers.

The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

In the embodiments of the present invention, application (entity) or resource related entity etc. may operate as devices in which they are installed or mounted, that is, a transmitting device 10 or a receiving device 20.

The specific features of the application (entity) or the resource related entity etc. such as the transmitting device or the receiving device may be implemented as a combination of one or more embodiments of the present invention described above in connection with the drawings.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable

1. A resource synchronization method of maintaining synchronization between an original resource and an announced resource in a wireless communication system, the method being performed by a first device and comprising:
checking an operation type of a request message when a target of the request message received from a second device is the announced resource;
determining whether an originator of the request message is a creator of the announced resource when the operation type is Update or Delete; and
granting a request indicated by the request message when the originator of the request message is the creator of the announced resource.

2. The resource synchronization method of claim 1, further comprising determining whether the target of the request message is the announced resource.

3. The resource synchronization method of claim 1, further comprising checking access rights of the second device using an access control policy of a target resource of the request message when the target of the request message is not the announced resource or when the operation type is not Update or Delete.

4. The resource synchronization method of claim 1, wherein the determining whether the originator of the request message is the creator of the announced resource includes comparing a “From” parameter of the request message with a “link” attribute of the announced resource.

5. The resource synchronization method of claim 1, further comprising denying the request indicated by the request message when the originator of the request message is not the creator of the announced resource.

6. A device for maintaining synchronization between an original resource and an announced resource in a wireless communication system, the device comprising:
a radio frequency (RF) unit; and
a processor configured to control the RF unit,
wherein the processor checks an operation type of a request message when a target of the request message received from a second device is the announced resource, determines whether an originator of the request message is a creator of the announced resource when the operation type is Update or Delete, and grants a request indicated by the request message when the originator of the request message is the creator of the announced resource.

7. The device of claim 6, wherein the processor determines whether the target of the request message is the announced resource.

8. The device of claim 6, wherein the processor checks access rights of the second device using an access control policy of a target resource of the request message when the target of the request message is not the announced resource or when the operation type is not Update or Delete.

9. The device of claim 6, wherein the processor compares a “From” parameter of the request message with a “link” attribute of the announced resource to determine whether the originator of the request message is the creator of the announced resource.

10. The device of claim 6, wherein the processor denies the request indicated by the request message when the originator of the request message is not the creator of the announced resource.
